(19) United States
(12) Patent Application Publication
(10) Pub. No.: US 2007/0284976 A1
(43) Pub. Date: Dec. 13, 2007

(54) Drawer slide structure having homing interlocking mechanism

(75) Inventor: Kuo-Sheng Huang, Ying Ghor Town (TW)

Correspondence Address: TROXELL LAW OFFICE PLLC, Suite 1404, 5205 Leesburg Pike, Falls Church, VA, 22041, US

(73) Assignee: Nan Juen International Co., Ltd.

(21) Appl. No.: 11/448,858

(22) Filed: Jun. 8, 2006

(51) Int. Cl. E05C 7/06

(52) U.S. Cl. 312/220

(57) ABSTRACT

A drawer slide structure comprises a slide base and a homing interlocking mechanism. The slide base is for holding passive and active movable devices. The active movable device is for shifting the passive movable device by outward movement of the drawer. The homing interlocking mechanism comprises a base, first and second pivotal rotating devices, and an elastic device. The homing interlocking mechanism is attached to the slide base to facilitate assembling production and damage repair. When the drawer shifts outward, the active movable device shifts the second and first pivotal rotating devices until being blocked by the retaining pillar and fixed by the pulling force of the elastic device. Besides, the lifting blocks on the first pivotal rotating device push the movable braking plates for achieving the purpose of interlocking. When the drawer shifts inward, the drawer slide shifts to its initial position automatically by the elastic device.

### FIELD OF THE INVENTION

The present invention relates to a drawer slide structure, and more particularly to a drawer slide structure having a homing interlocking mechanism to retrieve the position in an effort-saving manner.

### BACKGROUND OF THE INVENTION

For the purpose of pulling drawers more easily and conveniently, the drawer slide structures are widely applied between the drawers and the cabinets. However, the inertia force usually glides the slide structures when the push force is applied to the drawers to close and position the drawers, resulting in instability of the drawers in the cabinets. In order to improve this deficiency, a homing positioning member is attached to the rearward of the slide as disclosed in Taiwan Patent No. 468,437, entitled “automatic homing structure for slide”. However, this structure is complicated and expensive. Due to the rivet connection between the homing structure and the slide, it is not easy to repair them. In addition, at least two springs must be provided for balancing the pulling force. Moreover, the overuse or long-term use causes the elastic fatigue easily. Besides, the size of the homing structure must be incased for supplying the springs with sufficient space for movement.

Another deficiency of the coupled drawer slide and cabinet consists in that several drawers are arranged vertically in the cabinet, when one of the drawers is pulled outward, the drawers that locate above or under the drawer may also be pulled outward, causing inconvenience in use. Besides, the articles located inside the drawers are dropped out once the cabinet is tipped. In order to overcome this deficiency, interlock devices are disclosed in, for example, U.S. Pat. No. 6,238,024, entitled “Linkage member for anti-tip/interlock device” and U.S. Pat. No. 5,988,778, entitled “Rod-based file interlock system”.

These cited references may be able to overcome these deficiencies individually, but they cannot overcome these deficiencies simultaneously. As a result, there is a need to improve these conventional structures.

### SUMMARY OF THE INVENTION

A major purpose of the present invention is to provide a simplified, low-cost drawer slide structure having a homing interlocking mechanism so as to achieve the purposes of automatically retrieving position and interlocking.

Another object of the present invention to provide a drawer slide structure having a homing interlocking mechanism, wherein the homing interlocking mechanism is attached to the drawer slide by using through hole and positioning pin for facilitating the assembling production and the damage repair.

### BRIEF DESCRIPTION OF THE DRAWINGS

FIG. 1 is a three-dimensional view of the present invention.

FIG. 2 is a three-dimensional diagram viewed from another angle of FIG. 1.

FIG. 3 is a three-dimensional, exploded view of the present invention.

FIG. 4 is a three-dimensional, partial exploded view of the present invention.

FIG. 5 is a three-dimensional, partial assembled view showing the homing interlocking mechanism of the present invention.

FIG. 6 is a schematic view showing the preferred embodiment of the present invention in the closed status and the initial position.

FIG. 7 is a schematic diagram showing the lifting blocks viewed from another angle of FIG. 6.

FIG. 8 is a schematic view showing the open action of the preferred embodiment of the present invention.

FIG. 9 is a schematic diagram showing the lifting blocks viewed from another angle of FIG. 8.

FIG. 10 is a schematic showing the status of use of another preferred embodiment of the present invention.

### DETAILED DESCRIPTION OF THE PREFERRED EMBODIMENT

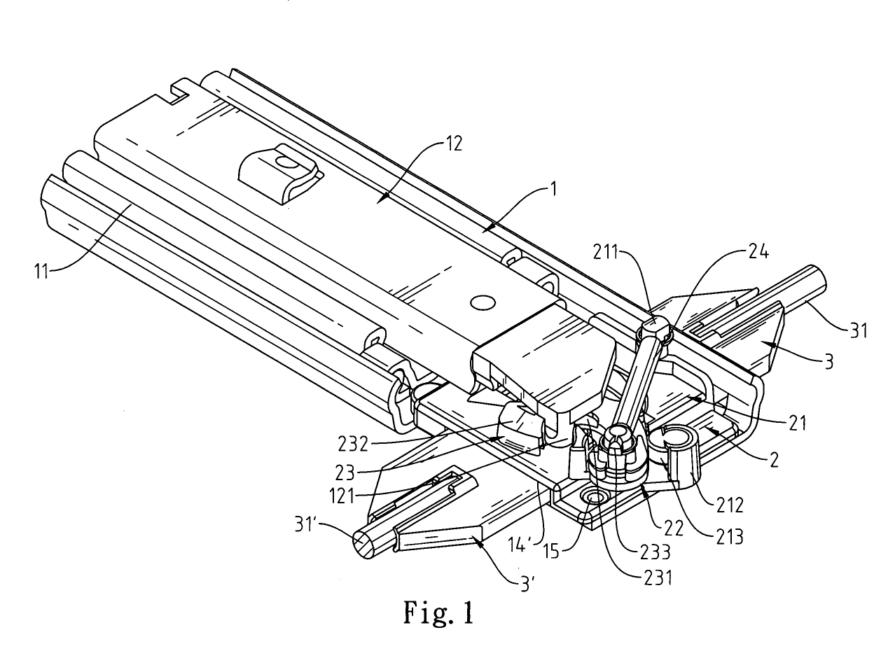

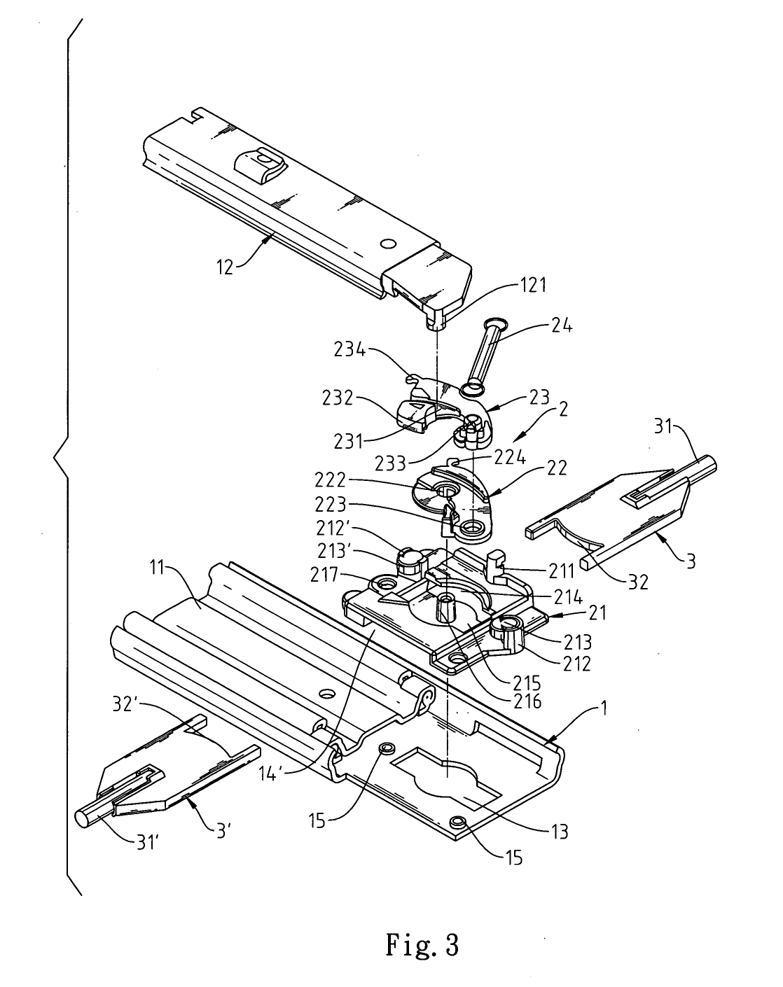

Referring to FIG. 1 through FIG. 5, a drawer slide structure comprises a slide base 1 and a homing interlocking mechanism 2, wherein the slide base 1 is bar-shaped and located on both sides of the cabinet. In addition, the center of the slide base 1 is a ditch for holding a passive movable device 11 to which an active movable device 12 is attached thereon, wherein the active movable device 12 is further attached to the drawer such that when the active movable device 12 is shifted over a proper distance by outward pulling the drawer, the passive movable device 11 is also shifted by the movement of the active movable device 12.

It is worthy to mention that a space is reserved in the rearward of the slide base 1 and a connection hole 13 is also formed on the rearward of the slide base 1 for holding the homing interlocking mechanism 2. In addition, a hooking rod 121 is protrudent downward from a front end of the active movable device 12.

The homing interlocking mechanism 2 comprises a base 21, a first pivotal rotating device 22, a second pivotal rotating device 23, and an elastic device 24.

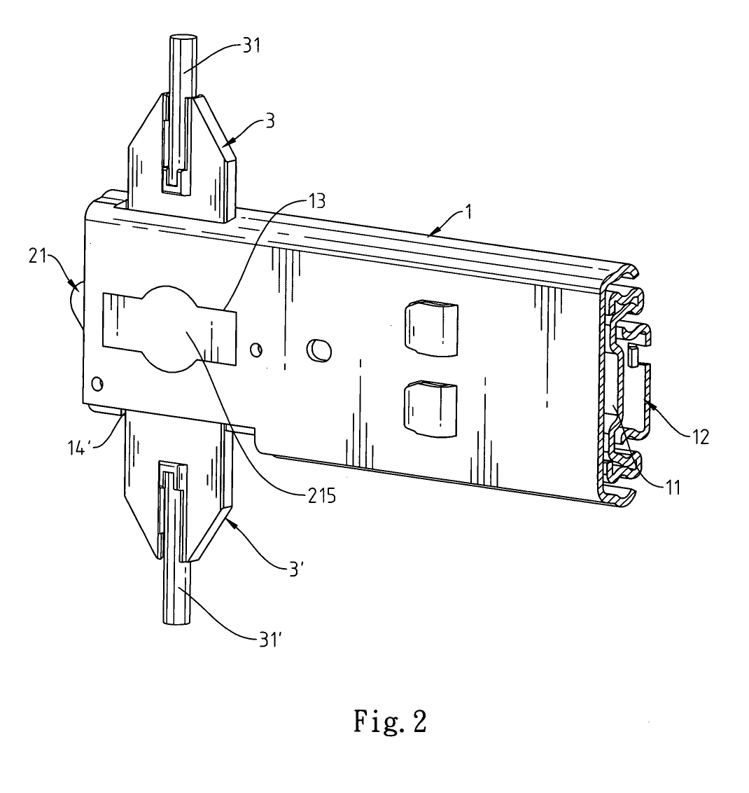

The base 21 is rectangular in shape. A protrudent pillar 211 is mounted vertically on a lateral of the base 21, and two retaining pillars 212 and 212′ are mounted oppositely on both sides of the base 21 and coupled with two soft buffer blocks 213 and 213′, respectively. An opening 214 is formed on the center of the base 21, and a connection plate 215 is protrusively mounted in the downward direction on the bottom of the base 21 corresponding to the opening 214 such that a depressed chamber is formed between the connection plate 215 and the opening 214 for holding the first pivotal rotating device 22. The connection plate 215 can be connectedly embedded into the connection hole 13, which is formed correspondingly on the rearward of the slide base 1, and affixed thereon by inserting a positioning pin 15 into a through hole 217 so as to integrate the homing interlocking mechanism 2 with the slide base 1, as shown in FIG. 2, wherein this coupling manner facilitates the assembling production and the damage repair. Besides, in the coupled homing interlocking mechanism 2 and slide base 1, two pivotal receiving holes are formed between two reverse U-shaped openings 14 and 14′, which are formed oppositely on both sides of the base 21, and the slide base 1 for insertion of two movable braking plates 3 and 3′ into the base 21 from opposite directions. Two braking rods 31 and 31′ are inserted into the center portions at respective first ends of the movable braking plates 3 and 3′. Two arc-shaped braking parts 32 are formed on respective second ends of the movable braking plates 3 and 3′, wherein the braking rods 31 and 31′ are interactively connected with the upper and lower drawers, respectively, for interlocking these drawers.

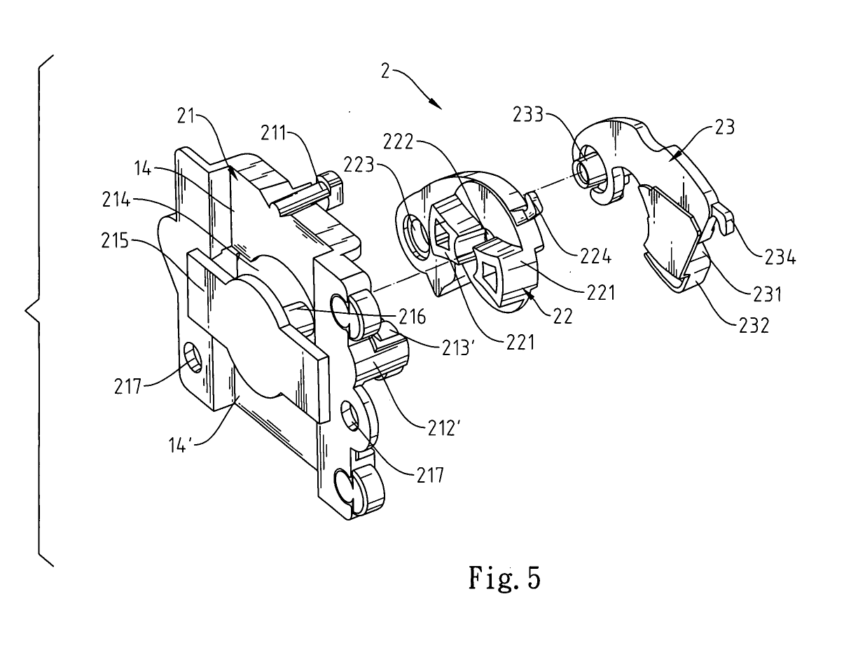

In addition, the first pivotal rotating device 22 is a curviform, long and narrow plate having two lifting blocks 221 mounted oppositely on the long and narrow bottom, as shown in FIG. 5. The first pivotal rotating device 22 is pivotally connected to a protrudent rod 216 of the connection plate 215 via a pivotal receiving hole 222 biasedly located on one side of the first pivotal rotating device 22. In addition, the second pivotal rotating device 23 is a fan-shaped plate with an arc-shaped depressed ditch 231 slightly parallel to the center of the arc-shaped surface of the second pivotal rotating device 23. An irregular-curved block 232 is formed on the lower end of the depressed ditch 231. The second pivotal rotating device 23 is coupled with the first pivotal rotating device 22 by inserting a vertically mounted insertion rod 233, which is opposite to the block 232, into a corresponding shaft hole 223 of the first pivotal rotating device 22. After the assembling of these two pivotal rotating devices is completed, the elastic device 24 is slantwise affixed between the insertion rod 233 and the protrudent pillar 211 of the base 21 such that the second pivotal rotating device 23 can make the left-right swing by using the protrudent pillar 211 as a relative pivot. Besides, two opposite-directed hooks 224 and 234 are located on the respective edges, which are located on the same side of the first and second pivotal rotating devices 22 and 23, respectively, and sleeved by an elastic band 4. The above-mentioned elastic device 23 is a spring that provides resilience, but not limited thereto.

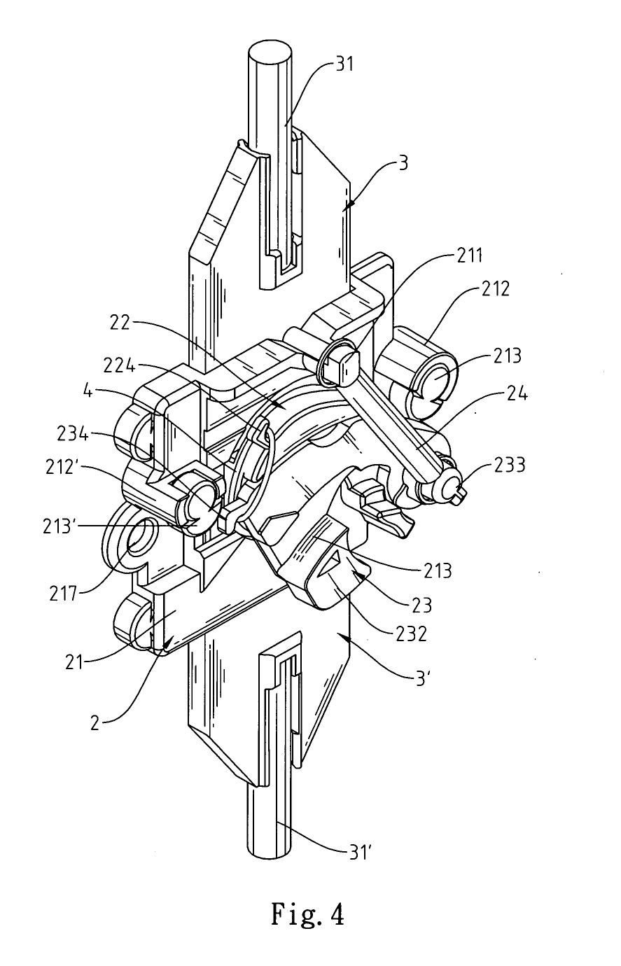

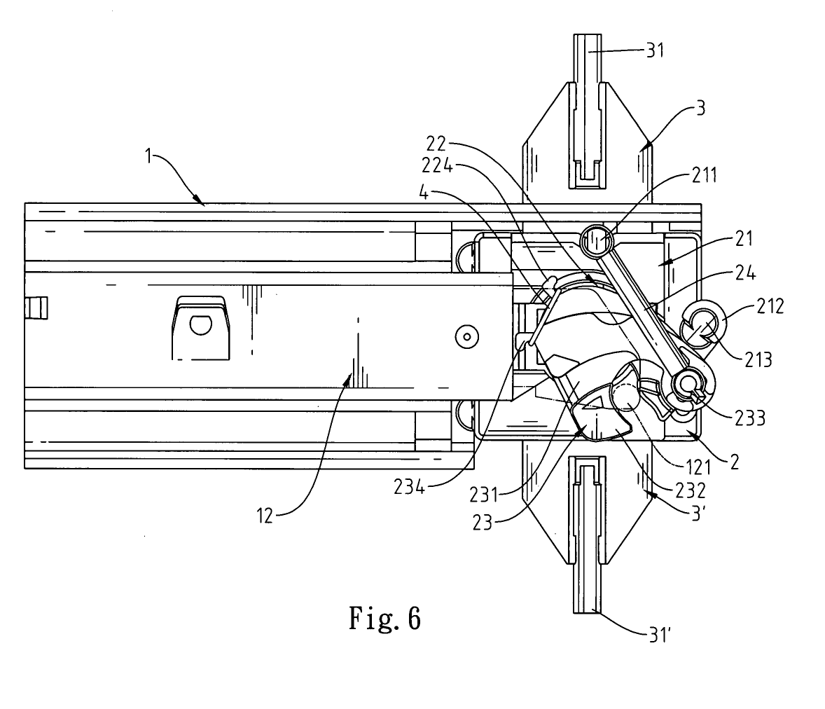

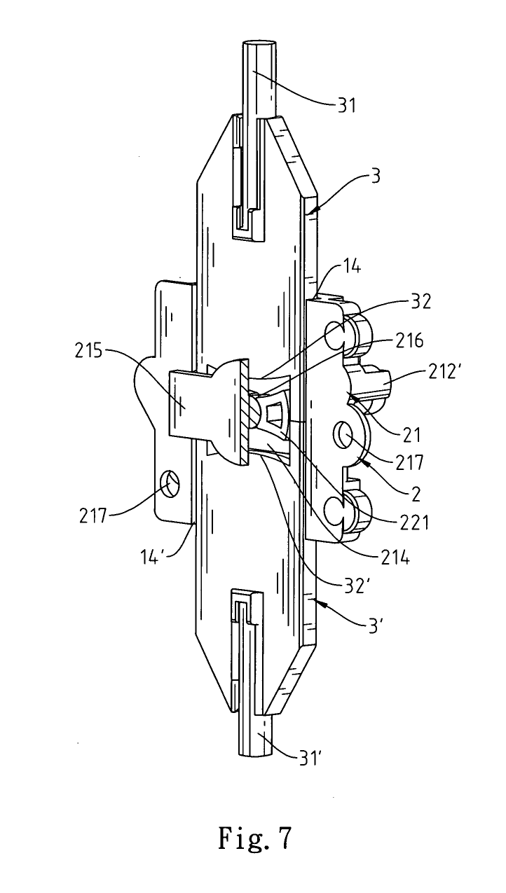

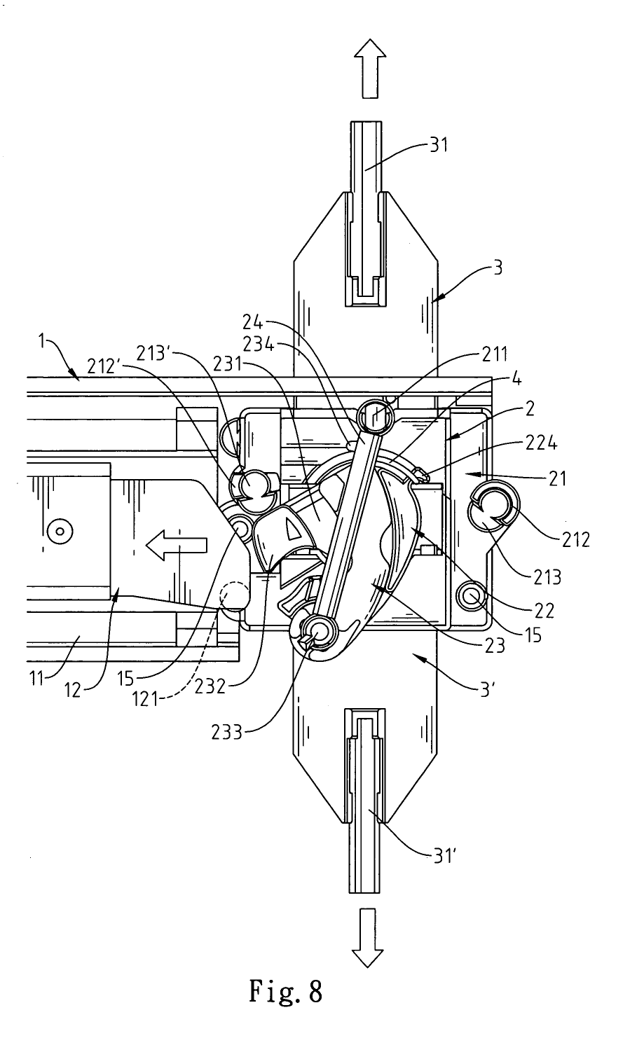

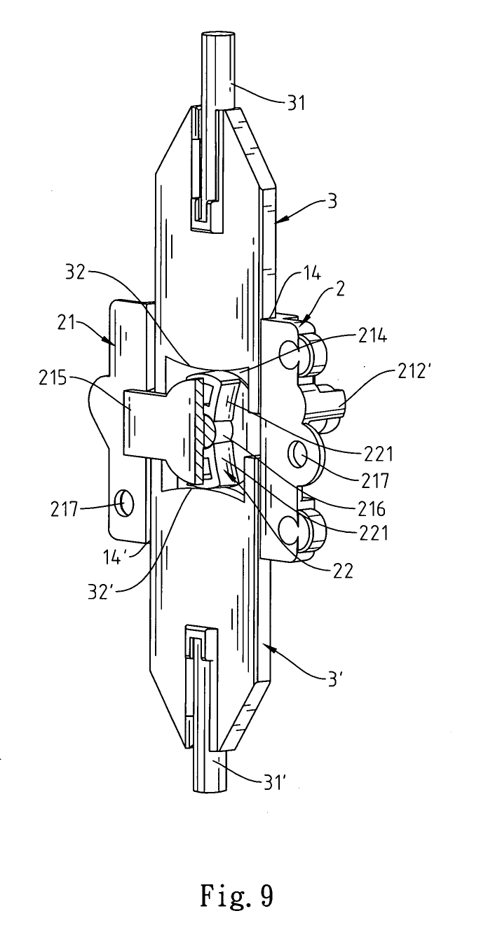

Referring further to FIG. 4 and FIG. 6 through FIG. 9, the integrated structure constituted by the coupling of the above-mentioned components is shown. Referring to FIG. 4 and FIG. 6, in the initial state that the drawer slide is in a closed position and not in action (shown in FIG. 6), the hooking rod 121, which is protrudent from the front end of the active movable device 12, hooks the inner edge of the block 232 of the second pivotal rotating device 23, and the lifting blocks 221, which are located on the bottom of the first pivotal rotating device 22, are perpendicular to the movable braking plates 3 and 3′, as shown in FIG. 7. As shown in FIG. 8 and FIG. 9, at the moment of pulling the drawer outward, the active movable device 12 is also shifted such that the second pivotal rotating device 23 is shifted outward by the hooking rod 121 of the active movable device 12, whereby the first pivotal rotating device 22 is also shifted by using the protrudent rod 216 as a pivot until the block 232 is leant against the retaining pillar 212′ and fixed by the pulling force of the elastic device 24. Besides, the distance of movement of the second pivotal rotating device 23 between these two retaining pillars 212 and 212′ is exactly sufficient to rotate the lifting blocks 221 by 90 degrees, as shown in FIG. 7 and FIG. 9, for pushing two braking parts 32 and 32′ of the movable braking plates 3 and 3′ such that the braking rods 31 and 31′ can be interactively interlinked to the braking rods of the upper and lower drawers. In addition, the contact points between the braking parts 32 and 32′ and the lifting blocks 221 are also arranged in an arc shape so as to reduce the value of error tolerance for controlling the movement of the movable braking plates 3 and 3′ precisely.

On the contrary, at the moment of pushing the drawer toward the inside of the cabinet, the front end of the active movable device 12 shifts the block 232 forward. Because both ends of the elastic device 24 are affixed between the insertion rod 233 and the protrudent pillar 211 of the base 21, when one end of the elastic device 24 is fixed, the other end of the elastic device 24 can be elongated by the movement of the second pivotal rotating device 23. In addition, the length between both ends of the elastic device 24 is shortened after the second pivotal rotating device 23 is shifted persistently over a proper distance. As a result, the pulling force caused by the length change of the elastic device 24 allows the second pivotal rotating device 23 to retrieve its initial position. Accordingly, the purposes of retrieving the position of the drawer slide can be achieved in an effort-saving manner without the need to push the drawer to the innermost position. It is specially mentioned that the elastic device 24 is momently in motion merely at the moment of pushing or pulling the drawer. The elastic device 24 is not elongated most of the time. As a result, it is not easy to cause the elastic fatigue after overuse or long-term use. Accordingly, its lifetime can be elongated. Besides, the mounting of the buffer blocks 213 and 213′ protects the pivotal rotating devices from being damaged by long-term collision between the pivotal rotating devices and the retaining pillars 212 and 212′ since the retaining pillars 212 and 212′ are for limiting the left-right swing of the pivotal rotating devices. Besides, the noise caused by the collision can be also diminished.

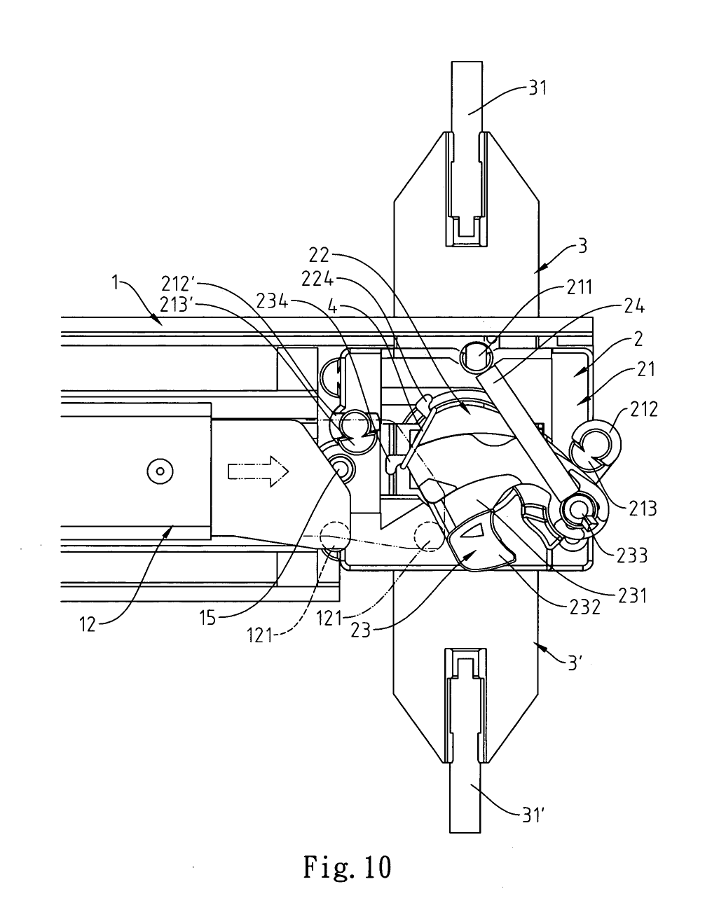

Referring further to FIG. 10, at the moment of pulling the drawer toward the outside of the cabinet, in some unanticipated situation such as collision or vibration, the elastic expansion and contraction of the elastic device 24 may drive the pivotal rotating devices to retrieve their positions first, causing the active movable device 12 unable to couple with the second pivotal rotating device 23. However, the mounting of the depressed ditch 231 prevents the occurrence of this problem, wherein when the active movable device 12 returns, the elastic band 4, which sleeves the pivotal rotating devices, produces the interactive pulling force between the pivotal rotating devices so as to enable the hooking rod 121 to get into the depressed ditch 231 easily and shift backward to its initial position along the depressed ditch 231 for making sure that the drawer slide is usable as normal condition.

What the invention claimed is:

1. A drawer slide structure having a homing interlocking mechanism comprising:
a slide base located on both sides of a cabinet, said slide base having a slide ditch for holding a passive movable device to which an active movable device is attached thereon, a space being reserved in a rearward of said slide base, a connection hole being formed on the rearward of said slide base for holding said homing interlocking mechanism, and said active movable device having a hooking rod protrudent from a front end thereof for controlling said homing interlocking mechanism; and
said homing interlocking mechanism comprising a rectangular base, a first pivotal rotating device, a second pivotal rotating device, and an elastic device, said base comprising a protrudent pillar mounted vertically on a lateral thereof, two retaining pillars mounted oppositely on both sides thereof, an opening formed on the center thereof, and a connection plate protrusively mounted in a downward direction on the bottom thereof so as to integrate said homing interlocking mechanism with said slide base, said first pivotal rotating device being a curviform, long and narrow plate having two oppositely mounted lifting blocks on the long and narrow bottom thereof, said first pivotal rotating device being connected to a protrudent rod of said connection plate via a pivotal receiving hole biasedly located on one side of said first pivotal rotating device, said second pivotal rotating device being a fan-shaped plate with an arc-shaped depressed ditch slightly parallel to an arc-shaped surface of said second pivotal rotating device, a block being formed on the lower end of said depressed ditch for being hooked by said hooking rod, a vertically mounted insertion rod, which is opposite to said block, being inserted into a corresponding shaft hole of said first pivotal rotating device.

2. The drawer slide structure having a homing interlocking mechanism of claim 1, wherein said retaining pillars are further coupled with two soft buffer blocks, respectively.

3. The drawer slide structure having a homing interlocking mechanism of claim 1, wherein an elastic device is slantwise affixed between said insertion rod and said protrudent pillar.

4. The drawer slide structure having a homing interlocking mechanism of claim 1, wherein an elastic device is slantwise affixed between said insertion rod and said protrudent pillar, and said elastic device is a spring.

5. The drawer slide structure having a homing interlocking mechanism of claim 1, wherein two opposite-directed hooks are located on the respective edges, which are located on the same side of said first and second pivotal rotating devices, and sleeved by an elastic band.

6. The drawer slide structure having a homing interlocking mechanism of claim 1, wherein two pivotal receiving holes are formed between two reverse U-shaped openings on both sides of said base and said slide base for holding two movable braking plates.

7. The drawer slide structure having a homing interlocking mechanism of claim 1, wherein two pivotal receiving holes are formed between two reverse U-shaped openings on both sides of said base and said slide base for holding two movable braking plates, two braking rods are inserted into center portions at respective first ends of said movable braking plates, and two arc-shaped braking parts are formed on respective second ends of said movable braking plates.
